(19) United States
(12) Patent Application Publication
(10) Pub. No.: US 2007/0148547 A1
(43) Pub. Date: Jun. 28, 2007

(54) Modification of an anode material and a preperation method thereof

(75) Inventors: Jenq-Gong Duh, Hsinchu City (TW); Li-Yin Hsiao, Tainan City (TW)

Correspondence Address: BIRCH STEWART KOLASCH & BIRCH, PO BOX 747, FALLS CHURCH, VA, 22040-0747, US

(73) Assignee: National Tsing Hua University

(21) Appl. No.: 11/313,792

(22) Filed: Dec. 22, 2005

(51) Int. Cl. H01M 4/58; B05D 5/12

(52) U.S. Cl. 429/231.8; 252/182.1; 427/122; 977/779

(57) ABSTRACT

A modification of an anode material, which is used as a carbonaceous material of an anode of a Lithium-ion secondary battery, is characterized in that the surface of the carbonaceous material is plated with Sn—P or Ni—Sn—P nanoparticles. The preparation method comprises the steps of mixing a reductant solution containing phosphorus ions and an oxidant solution containing stannous ions or nickel and stannous ions to form a plating liquid, disposing a carbonaceous material into said plating liquid with pH between 3-5, and heating the environmental temperature up to 80° C.- 85° C. for 2 hours for performing an electroless plating reaction. After the carbonaceous material is cooled to room temperature, cleaning the carbonaceous material by using deionzied water. Finally, baking and drying the carbonaceous material, and a carbonaceous material with surface thereof plated with Sn—P or Ni—Sn—P nanoparticles is obtained.

### FIELD OF THE INVENTION

The present invention relates to a modification of an anode material and a preparation method thereof, and particularly to a modification that employs to prepare an anode material of a Lithium-ion secondary battery such that the Lithium-ion secondary battery can achieve a better charge/discharge effect.

### BACKGROUND OF THE INVENTION

In the past, a variety of secondary batteries have been used including lead-acid, nickel cadmium, nickel hydrogen and lithium ion battery. The lead-acid battery is mostly used to electric tools or electric vehicles due to its large volume. The nickel cadmium battery is apt to cause the pollution of the environment. The nickel hydrogen battery has less charge capacity, short cycle life and poor memory effect. Therefore, the three above-mentioned are gradually replaced by the Lithium-ion secondary battery.

The charge/discharge principle of a whole Lithium battery depends on the transferring Lithium-ions between an anode and a cathode. For example, while the battery charging, Lithium-ions are inserted into the anode material from Lithium, Lithium-cobalt, Lithium-cobalt-nickel, or Lithium-manganese oxides. In the transferring process, Lithium-ions will be transferred into the cathode material by passing through separation films, via an electrolyte. While discharging, Lithium-ions return to the anode material of the original structure from the cathode material via the electrolyte and separated films.

Two electrode materials (i.e., anode and cathode) are capable of allowing more Lithium-ions to enter or release, which means that the capacity of a Lithium battery with such an electrode material will be higher relatively. For example, the anode is a group of pitchers, the cathode is a group of catchers, and Lithium-ions are balls, if the pitchers throw more balls and all of the balls can be caught by the catchers, this means the safety of Lithium-ions is high and the battery has more charge capacity. If the catchers bobble the balls thrown by the pitchers, not only the charge capacity will be insufficient but also the safety concerns exist.

Carbonaceous material is widely used as the anode material of a Lithium-ion battery. The advantages of the material are that it has high specific capacity (200 mAh/g -400 mAh/g), low electrode potential (<1.0 V, vs. Li+/Li), high cycle efficiency (>95%), long cycle life and no metal Lithium existing in the battery thus without the safety problem.

The theoretical formula of Lithium compound usually formed in a carbonaceous material is LiC_{6.} The theoretical specific capacity by Stoichiometry is 372 mAh/g such as a MesoCarbonMicroBead (MCMB). As shown in FIG. 1, it shows a relationship diagram of the charge/discharge specific capacity vs. charge/discharge cycle times of the MCMB, with cutoff voltage ranging from 0V to 1.5V. The charge/discharge specific capacity of the MCMB is 300-340 mAh/g and has an extremely well cyclability.

Recently, as the research about carbonaceous materials have been constantly gone deeper, it has been found that, surface modification and structure adjustment by using graphite and various carbonaceous materials, randomizing the graphite portion, or forming nano-grade apertures, holes and channels in various carbonaceous materials such that the insertion/extraction of Lithium therein not only can perform according with the Stoichiometric LiC₆ but also nonstoichiometric insertion/extraction available, which substantially increases the specific capacity thereof, raises the theoretic value of LiC₆ from 372 mAh/g to 700 mAh/g˜1000 mAh/g. Thus the specific capacity of the Lithium-ion secondary battery substantially increases.

As for the Lithium-ion secondary battery that uses Tin as the modification basis, it is mainly formed by intermetallic tin alloy (MₓSn), such as Cu₆Sn₅, SnMnC, FeSn₂, FeSn, Ni₃Sn₄, and tin oxide. The theoretic specific capacity of Li_{4.4}Sn by Stoichiometry reaches further up to 991 mAh/g.

But, there is a major drawback in the above method. The volume of the Tin alloy (LiₓSn) will increase 259% along during the lithiation processes in lithium-tin alloys. The increased volume may cause electrode severe disintegration (fast growth and cracking and crumbling).

Therefore, how to obtain a carbonaceous anode material that uses Tin as modification basis to achieve a Lithium-ion secondary battery having high storage capacity, high safety and stable cyclability should be the upmost problem of current Lithium-ion secondary battery need to be solved.

### SUMMARY OF THE INVENTION

Accordingly, in order to solve the above-mentioned problems, the major object of the present invention is to provide a modification method of a carbonaceous anode material of Lithium-ion secondary batteries, which increases the specific capacity of the carbonaceous anode material and without fast expansion of volume thereof.

Another object of the present invention is to maintain stable cyclability and prolong cycling of a Lithium-ion secondary battery in the case that the specific capacity of the carbonaceous anode material increases.

The further object of the present invention is to provide a modification method for a carbonaceous anode material, said modification method is a safe and effective process suitable for business mass production.

The present invention discloses a modification of an anode material. The anode material, used as the carbonaceous material of the anode of Lithium-ion secondary battery, is characterized in that the surface of the carbonaceous material is plated with Sn—P nanoparticles, or Ni—Sn—P nanoparticles by using an electroless plating reaction.

The preparation method comprises the steps of, firstly, formulating a reductant solution containing phosphorus ions and an oxidant solution containing stannous ions or nickel and stannous ions, adding the oxidant solution into the reductant solution to form a plating liquid as the reductant solution being stirred fast, then disposing a carbonaceous material into the plating liquid with pH between 3-5, stirred fast and heating the environmental temperature up to 80° C.-85° C. and maintaining the temperature for 2 hours for performing an electroless plating reaction. After the electroless plating reaction, the carbonaceous material is cooled to room temperature, and then cleaned by using deionized water. Finally, the cleaned carbonaceous material is baked and dried by using a vacuum oven, and thus obtains a carbonaceous material with surface thereof plated with Sn—P or Ni—Sn—P nanoparticles.

### BRIEF DESCRIPTION OF THE DRAWINGS

FIG. 1 shows a relationship diagram of the charge/discharge specific capacity vs. the charge/discharge cycle times of a MCMB with cutoff voltage ranging from 0V to 1.5V.

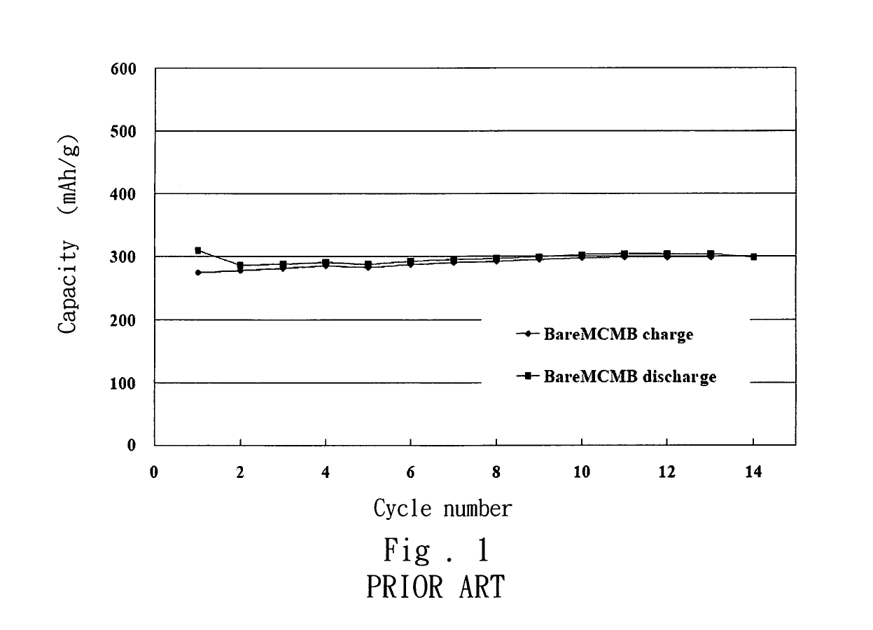

FIG. 2 schematically shows a flowchart of the present invention.

FIG. 3 shows an X-ray Diffraction (XRD) image of a MCMB surface plated with Sn—P nanoparticles.

FIG. 4 shows an X-ray Diffraction (XRD) image of a MCMB surface plated with Ni—Sn—P nanoparticles.

FIG. 5 shows a relationship diagram of the specific capacity vs the charge/discharge cycle times of Lithium-ion secondary batteries uncoated (Bare MCMB) and modified (SnP/MCMB).

FIG. 6 shows a relationship diagram of the specific capacity vs the charge/discharge cycle times of Lithium-ion secondary batteries uncoated (Bare MCMB) and modified (NiSnP/MCMB).

### DETAILED DESCRIPTION OF THE PREFERRED EMBODIMENTS

Now, the present invention will be disclosed more fully from the following detail content and technical specifications with reference to the accompanying drawings.

The present invention is a modification of an anode material. The anode material, used as the carbonaceous material of the anode of Lithium-ion secondary battery, is characterized in that the surface of the carbonaceous material is plated with Sn—P nanoparticles or Ni—Sn—P nanoparticles, wherein the carbonaceous material comprises Sn—P or Ni—Sn—P in the range of 5-30 wt %.

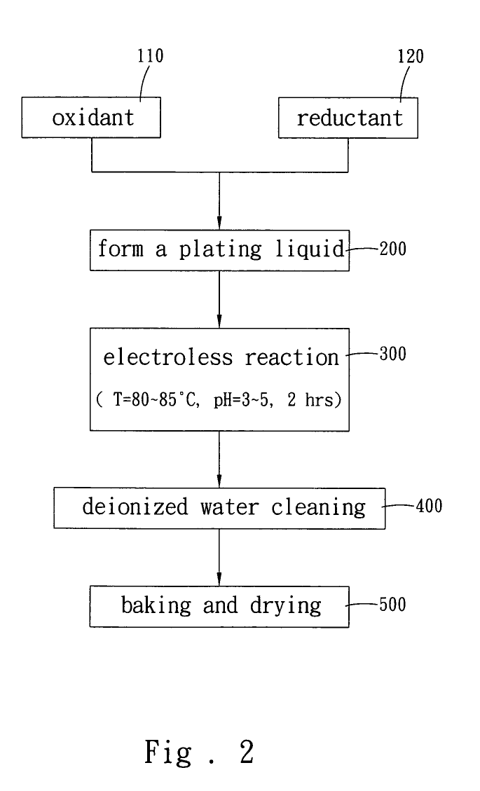

Referring to FIG. 2, it schematically shows a flowchart of the present invention. A preparation method for modifying an anode material according to the present invention comprises the steps of:
(a) Formulating a reductant solution containing phosphorus ions (step 120), wherein the reductant is composed of 54 g/L Sodium Hypophosphite (NaH₂PO₂) and 32 g/L Sodium Succinate.

Formulating an oxidant solution containing stannous ions (step 110), wherein the oxidant solution is 0.08 M Stannous Sulfate. Or, the oxidant solution contains nickel ions and stannous ions, wherein the oxidant solution is composed of 0.06 M Nickel sulfate and 0.08 M Stannous sulfate.
(b) As the reductant solution being stirred fast, the oxidant solution is added into the reductant solution to form a plating liquid for a subsequent electroless plating reaction (step 200).
(c) Disposing a carbonaceous material used as an anode material of a Lithium-ion secondary battery into the electroless plating liquid for performing an electroless reaction, wherein when the plating liquid being stirred fast, with pH between 3 to 5, and the electroless environmental temperature is heated up to 80° C.-85° C. for 2 hours (step 300).
(d) After the electroless plating reaction have been performed by the previous step, the carbonaceous material is cooled to room temperature and then the carbonaceous material is cleaned by using deionized water (step 400).
(e) Baking and drying the carbonaceous material cleaned by the previous step using a vacuum oven (step 500). Thus, a carbonaceous material with surface thereof plated with Sn—P nanoparticles or Ni—Sn—P nanoparticles is obtained, and the carbonaceous material is used as a carbonaceous material of an anode material of a Lithium-ion secondary battery.

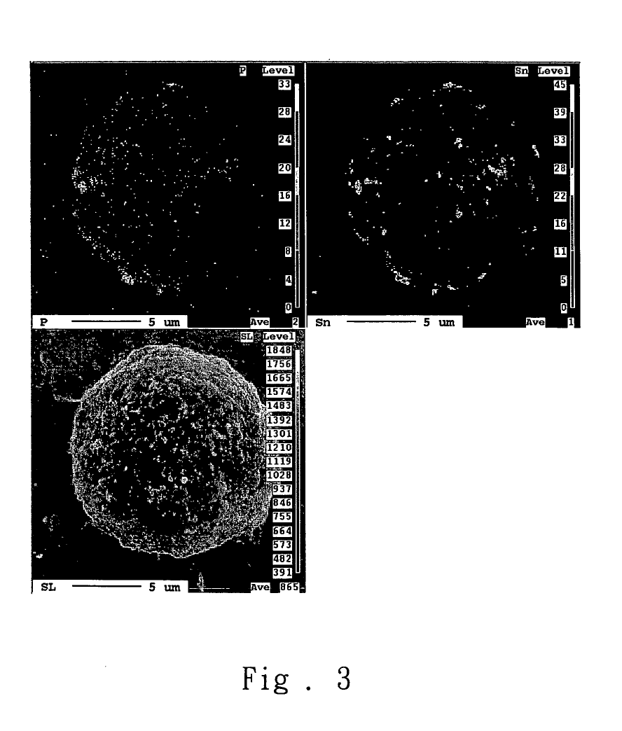

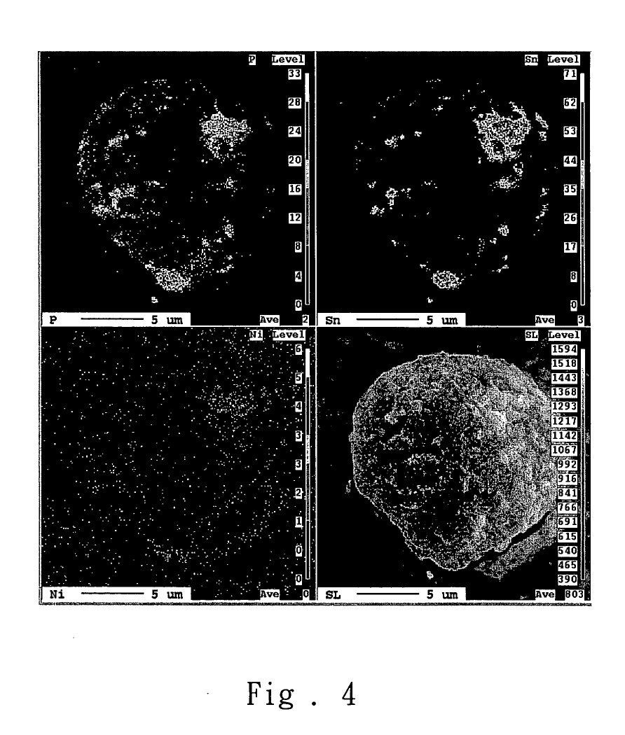

Referring to FIGS. 3 and 4, there are X-ray Diffraction (XRD) images of a carbonaceous material such as MCMB, with surface thereof plated with Sn—P nanoparticles and Ni—Sn—P nanoparticles, respectively. As can be seen obviously in FIG. 3, Sn—P nanoparticles are plated uniformly on the surface of the carbonaceous material (MCMB). It is obvious in FIG. 4 that Ni—Sn—P nanoparticles are plated uniformly on the surface of the carbonaceous material (MCMB). Due to Sn containing nanoparticles being plated uniformly on the surface of the carbonaceous material (MCMB), the electrode can effectively avoid severe disintegration caused by the volume expansion thereof.

According the above description, the present invention which can be used as a modification of an anode material of a Lithium-ion secondary battery and a preparation method thereof, is an effective process suitable for business mass production. Besides, Sn—P nanoparticles or Ni—Sn—P nanoparticles can be uniformly plated on the surface of the carbonaceous material. Thus the modification of a carbonaceous material can be used as the anode material of a Lithium-ion secondary battery.

Now the carbonaceous materials (such as MCMBs) made by the above-mentioned preparation method of the present invention, an uncoated (Bare MCMB) and a modified (containing Sn—P nanoparticles) (SnP/MCMB) carbonaceous materials, are used as the electrode materials of the Lithium-ion secondary batteries respectively. The testing uses a mixture of the carbonaceous material (such as a MCMB) and an adhesive as the working electrode (relative to the cathode), and a lithium metal foil as the reference electrode (relative to the anode), and LiPF₆ is dissolved into a 1M solution of Ethylene-carbonate (EC) and Diethyl-carbonate (DEC) as the electrolyte, so as to assemble a Lithium secondary battery, wherein the carbonaceous material comprises 30 wt % Sn—P nanoparticles.

The above assembled Lithium secondary battery is disposed on a channel battery testing system, with charging/discharging current being set to be 0.1C and the charging/discharging cutoff voltage in the range of 0V -1.5V. A continuously charging/discharging test is conducted, and the change of voltage and time are recorded by a computer. The carbonaceous material uncoated (Bare MCMB) and modified (SnP/MCMB), and the specific capacity (mAh/g) of each cycle at charge/discharge are measured to obtain a table as follows:

| specific capacity | | 1^{st} | 3^{rd} | 13^{th} |
|---|---|---|---|---|
| (mAh/g) | | cycle | cycle | cycle |
| SnP/MCMB | charge | 385.91 | 488.72 | 441.24 |
| | discharge | 442.57 | 501.76 | 448.49 |
| Bare MCMB | charge | 274.12 | 280.66 | 297.65 |
| | discharge | 309.07 | 287.35 | 303.25 |

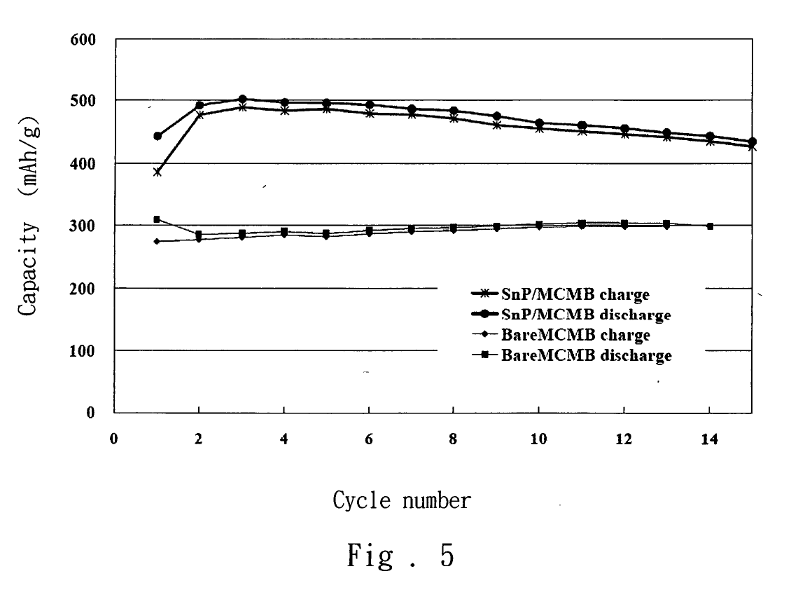

Referring to FIG. 5, it shows a relationship diagram of the discharge specific capacity vs. the charge/discharge cycle times of carbonaceous materials uncoated and modified (with Sn—P nanoparticles) according to the present invention, both used as the anode of a Lithium-ion secondary battery with cutoff voltage ranging from 0V to 1.5V. As can be seen obviously in the Figure, after the anode of the battery modified according to the present invention (SnP/MCMB) operates for a certain cycle times, the charge/discharge specific capacity of the battery is larger than that of the anode uncoated (Bare MCMB) and has a extremely well cyclability.

Furthermore, according to the preparation method of the present invention, carbonaceous materials (such as MCMBs) uncoated (Bare MCMB) and modified (containing Ni—Sn—P nanoparticles) (NiSnP/MCMB) both are used as the anode of a Lithium-ion secondary battery with other conditions similar to the previous. The carbonaceous material uncoated (Bare MCMB) and modified (SnP/MCMB), and the specific capacity (mAh/g) of each cycle at charge/discharge are measured to obtain a table as follows:

| | | 1^{st} | 3^{rd} | 13^{th} |
|---|---|---|---|---|
| specific capacity(mAh/g) | | cycle | cycle | cycle |
| NiSnP/MCMB | charge | 267.63 | 415.69 | 406.48 |
| | discharge | 516.09 | 434.88 | 420.95 |
| Bare MCMB | charge | 274.12 | 298.12 | 297.65 |
| | discharge | 309.07 | 303.83 | 303.25 |

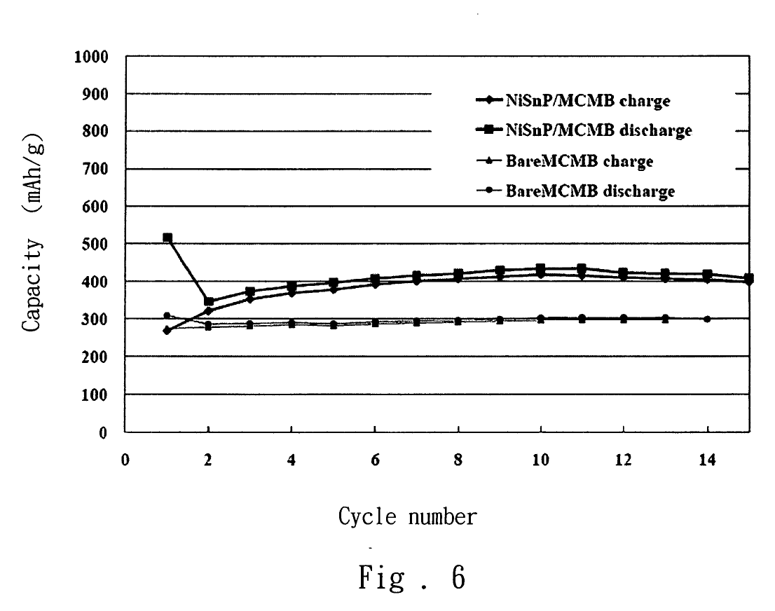

Referring to FIG. 6, it shows a relationship diagram of the discharge specific capacity vs. the charge/discharge cycle times of carbonaceous materials uncoated(Bare MCMB) and modified (NiSnP/MCMB)according to the present invention, both are used as the anode of a Lithium-ion secondary battery with cutoff voltage ranging from 0V to 1.5V. As can be seen obviously in the Figure, after the anode of the battery modified according to the present invention (NiSnP/MCMB) operates for a certain cycle times, the charge/discharge specific capacity of the battery is larger than that of the anode uncoated(Bare MCMB) and has a extremely well cyclability.

However, the above mentioned, merely the preferred embodiments of the present invention, are not intended to limiting the scope of the present invention. Accordingly, all variations and modifications made according to the claims of the present invention are contemplated by this invention.

What is claimed is:

1. A modification of an anode material, which is used as a carbonaceous material of an anode of a Lithium-ion secondary battery, is characterized in that the surface of the carbonaceous material is plated with Sn—P nanoparticles.

2. The modification according to claim 1, wherein the carbonaceous material comprises said Sn—P nanoparticles in the range of 5-30 wt %.

3. A modification of an anode material, which is used as a carbonaceous material of an anode of a Lithium-ion secondary battery, is characterized in that the surface of the carbonaceous material is plated with Ni—Sn—P nanoparticles.

4. The modification according to claim 3, wherein the carbonaceous material comprises said Ni—Sn—P nanoparticles in the range of 5-30 wt %.

5. A preparation method for modifying an anode material comprising the steps of:
(a) Formulating a reductant solution containing phosphorus ions and an oxidant solution containing stannous ions;
(b) Adding the oxidant solution into the reductant solution to form a plating liquid as the reductant solution being stirred fast;
(c) Disposing a carbonaceous material into the plating liquid, fast stirred with pH between 3 to 5, heating the environmental temperature up to 80° C.-85° C. and maintaining the temperature for 2 hours for performing an electroless plating reaction;
(d) After the electroless plating reaction, cooling the carbonaceous material to room temperature and then cleaning the carbonaceous material by using deionized water;
(e) Baking and drying the cleaned carbonaceous material by using a vacuum oven.

6. The preparation method according to claim 5, wherein the reductant is composed of 54 g/L Sodium Hypophosphite (NaH₂PO₂) and 32 g/L Sodium Succinate.

7. The preparation method according to claim 5, wherein the oxidant solution is 0.08 M Stannous Sulfate.

8. The preparation method according to claim 5, wherein the oxidant further includes nickel ions, the oxidant solution is composed of 0.06 M Nickel sulfate and 0.08 M Stannous sulfate.
